(19) United States
(12) Patent Application Publication
(10) Pub. No.: US 2017/0251088 A1
(43) Pub. Date: Aug. 31, 2017

(54) PORTABLE ELECTRONIC DEVICE HOLDER

(71) Applicant: Jacqueline Rosales, San Clemente, CA (US)

(72) Inventor: Jacqueline Rosales, San Clemente, CA (US)

(21) Appl. No.: 15/054,439

(22) Filed: Feb. 26, 2016

(51) Int. Cl. H04M 1/04

(52) U.S. Cl. CPC H04M 1/04

(57) ABSTRACT

A portable electronic device holder that includes: a handle, where the handle include a first end and a second end; a connector at the first end, where the connection includes a plug adapted to engage a portable electronic device; and a stylus at the second end, where the stylus is adapted for use on an input component of the portable electronic device. The handle is preferably configured in a pen or popsicle-stick like configuration. The portable electronic device holder may be a smartphone or tablet, where the input component is a touchscreen and the plug engages a power-charging receptacle of the smartphone during use.

### BACKGROUND OF THE INVENTION

Field of Invention

The present invention relates to a handle that is used to support and hold a portable electronic device such as a smartphone.

Description of Related Art

Portable electronic devices in the form of smartphones and tablets are used throughout the world. These are convenient electronic devices that provide all types of communication and data applications to enhance and supplement daily tasks for the individual user. Further these devices are used for entertainment purposes such as games, music, and video viewing. The smartphone or handheld portable electronic device typically includes a touchscreen as the primary input protocol. The touchscreen also enables the user to engage in various types of gaming that may be associated with various electronic applications available on the smartphone. Most smartphones come in various sizes however sometimes it is difficult to handle and maneuver the smartphone for some individuals due to the size of their hands or fingers. As a result, it would be advantageous to have a handle that connects to the electronic device or smartphone to provide a means to support and engage with the smartphone also alleviating the inadvertent touchscreen inputs.

### SUMMARY OF THE INVENTION

The present invention relates to a portable electronic device holder that includes: a handle, where the handle include a first end and a second end; a connector at the first end, where the connection includes a plug adapted to engage a portable electronic device; and a stylus at the second end, where the stylus is adapted for use on an input component of the portable electronic device. The handle is preferably configured in a pen or popsicle-stick like configuration. The portable electronic device holder may be a smartphone, where the input component is a touchscreen and the plug engages a power receptacle of the smartphone during use.

### BRIEF DESCRIPTION OF DRAWINGS

FIG. 1 depicts a portable electronic device holder in accordance with the present invention.

FIG. 2 depicts the portable electronic device holder engaged with a smartphone.

### DETAILED DESCRIPTION

The present invention relates to a pen or popsicle-stick type holder that is inserted into a smartphone to provide a means to handle and support a smartphone. The present invention includes a handle with a connector at one end and a stylist tip at the opposing end. Preferably the handle has a pen or popsicle-stick type shape and enables the user to insert the connector into the charging power outlet of the device, which allows the user to handle and maneuver the phone or tablet with the handle. Further the handle includes a stylist pen tip, which enables the user to use the handle as a touch stylist for the smartphone or tablet touchscreen.

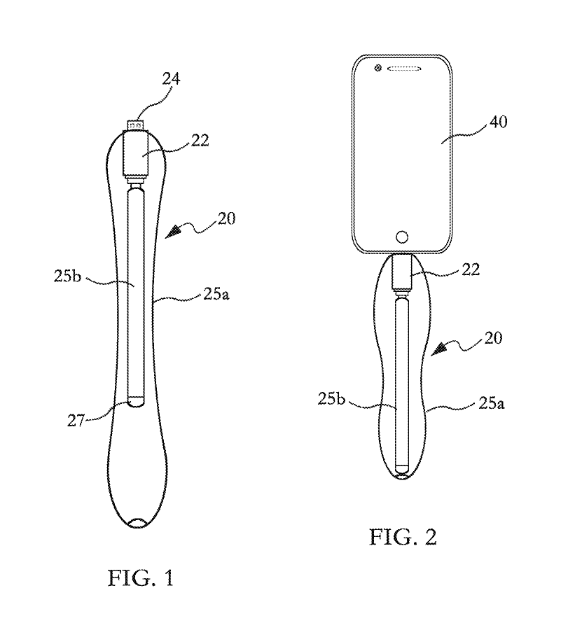

In reference to FIG. 1, electronic device holder 20 in accordance with the present invention is depicted. The holder 20 includes a handle 25 in a pen 25b or popsicle-stick 25a type of a configuration. A handle 25 includes a first end that includes a connector 22 and a second end that includes a stylist tip 27. The connector 22 includes a plug 24 that may be inserted into the power-charging receptacle for a smartphone or tablet. The plug 24 may be custom configured for use with some of the popular connections available for smartphones and tablets.

FIG. 2 depicts use of the holder 20 in conjunction with a smartphone 40. This holder 20 is shown with the connector 22 inserted into a power-charging receptacle on the smartphone 40. Once inserted a user may easily use this holder to support and maneuver the smartphone as needed. The instant invention has been shown and described in what it considers to be the most practical and preferred embodiments. It is recognized, however, that departures may be made there from within the scope of the invention and that obvious modifications will occur to a person skilled in the art.

1. A portable electronic device holder comprising:
a) a handle, where the handle include a first end and a second end, and the handle is configured in a pen or popsicle-stick like configuration;
b) a connector at the first end, where the connection includes a plug adapted to engage a portable electronic device through a USB receptacle; and
c) a stylus at the second end, where the stylus is adapted for use on an input component of the portable electronic device.

2. (canceled)

3. The portable electronic device holder according to claim 1, where the portable electronic device is a smartphone or tablet.

4. The portable electronic device holder according to claim 3, where the input component is a touchscreen.

5. The portable electronic device holder according to claim 3, where the plug engages a power-charging receptacle during use.
